(19) United States
(12) Patent Application Publication
(10) Pub. No.: US 2021/0027239 A1
(43) Pub. Date: Jan. 28, 2021

(54) SYSTEM AND METHOD OF ASSET TRACKING

(71) Applicant: Relola, Inc., Emeryville, CA (US)

(72) Inventors: Heather L. Sittig, Oakland, CA (US); Graham Golder, Fremont, CA (US)

(21) Appl. No.: 16/940,129

(22) Filed: Jul. 27, 2020

Related U.S. Application Data
(60) Provisional application No. 62/879,412, filed on Jul. 26, 2019.

(51) Int. Cl. G06Q 10/08; G06F 16/953

(52) U.S. Cl. CPC G06Q 10/087; G06F 16/953

(57) ABSTRACT

A method comprising receiving, from a first service provider over a network, a first asset update, receiving, from a second service provider over the network, a second asset update, the second entity being unrelated and remote from the second entity, receiving a first search request from a first user associated with the first entity, placing a first map marker on a first map, in response to an interaction of the first map marker, the first map displaying the first asset identifier and the first timestamp, receiving a second search request from a second user associated with the second entity, placing a second map marker on a second map, in response to an interaction by the second user on the second map marker, the second map displaying the second asset identifier and the second timestamp.

### CROSS REFERENCE TO RELATED APPLICATIONS

The present application claims benefit of U.S. Provisional Patent Application No. 62/879,412 filed Jul. 26, 2019, and entitled “System and Method of Asset Tracking,” which is incorporated by reference herein.

### FIELD OF THE INVENTION

Embodiments of the present application related generally to tracking and monitoring assets.

### SUMMARY

An example nontransitory computer readable medium comprising instructions executable by a processor, the instructions being executable to perform a method, the method comprising receiving, from a first service provider over a network, a first asset update, the first asset update including a first asset identifier identifying a particular first asset, a first timestamp, and a location of the first asset, the first asset being owned by a first entity, the first service provider having been approved by the first entity to provide updates regarding a set of assets belonging to the first entity, creating and storing a first asset entry associated with the particular first asset, the asset entry including the location of the first asset and the first timestamp, the first timestamp indicating a first time when the first asset update was created by the first service provider, receiving, from a second service provider over the network, a second asset update, the second asset update including a second asset identifier identifying a particular second asset, a second timestamp, and a location of the second asset, the second asset being owned by a second entity, the second service provider having been approved by the second entity to provide updates regarding a set of assets belonging to the second entity, the second entity being unrelated and remote from the second entity, creating and storing a second asset entry associated with the particular second asset, the second asset entry including the location of the second asset and the second timestamp, the second timestamp indicating a second time when the second asset update was created by the second service provider, receiving a first search request from a first user associated with the first entity, the first search request identifying a subset of assets belonging to the first entity, based on the first search request, retrieving, from the first entry, the first asset identifier, the first timestamp, and the location of the first asset, placing a first map marker on a first map, the first map marker corresponding to the location of the first asset, providing the first map to the first user, the first map marker being interactive, in response to an interaction by the first user on the first map marker, the first map displaying the first asset identifier and the first timestamp, receiving a second search request from a second user associated with the second entity, the second search request identifying a subset of assets belonging to the second entity, based on the second search request, retrieving, from the first entry, the second asset identifier, the second timestamp, and the location of the second asset, placing a second map marker on a second map, the second map marker corresponding to the location of the second asset, and providing the second map to the second user, the second map marker being interactive, in response to an interaction by the second user on the second map marker, the second map displaying the second asset identifier and the second timestamp.

In some embodiments, wherein the first and second map display the same location. In various embodiments, the first asset provider is the second asset provider. In other embodiments, the first asset provider is unrelated to the second asset provider. Providing the first map to the first user may comprise displaying a web page depicting the first map, the first search request being received from the first user using a web site.

The first search request may be received from the first user using a remote web site operated by a third-party and providing the first map to the first user may comprise providing code to display the first map within a section of a web page of the web site such that the first map appears as if the first map is provided by the third-party. In some embodiments, the first asset update may include an image of the particular first asset taken by the first service provider at or near a time that the first service provider provided the first asset update, the first map being interactive to display the image of the particular first asset when the first user interacts with the first map marker.

In some embodiments, the first asset is equipment and the second asset is a service. In some embodiments, the first asset is equipment and the second asset is a service.

In various embodiments, the method further comprising: receiving, from any number of service providers over the network, a plurality of updates, the plurality of updates each including the first asset identifier identifying the particular first asset, a timestamp for that particular update, and a location of the first asset at or near the time that the particular update was created, and creating and storing each of the updates, wherein the first search request further including a date range, wherein the first map includes a set of map markers, each of the set of map markers being located on the first map at or near the locations of the first asset at a time within the date range, each of the map markers displaying, when interacted with by the first user, the timestamp corresponding to that particular update created during the duration. In some embodiments, each of the set of map markers is colored based on time of the corresponding update.

An example method comprises receiving, from a first service provider over a network, a first asset update, the first asset update including a first asset identifier identifying a particular first asset, a first timestamp, and a location of the first asset, the first asset being owned by a first entity, the first service provider having been approved by the first entity to provide updates regarding a set of assets belonging to the first entity, creating and storing a first asset entry associated with the particular first asset, the asset entry including the location of the first asset and the first timestamp, the first timestamp indicating a first time when the first asset update was created by the first service provider, receiving, from a second service provider over the network, a second asset update, the second asset update including a second asset identifier identifying a particular second asset, a second timestamp, and a location of the second asset, the second asset being owned by a second entity, the second service provider having been approved by the second entity to provide updates regarding a set of assets belonging to the second entity, the second entity being unrelated and remote from the second entity, creating and storing a second asset entry associated with the particular second asset, the second asset entry including the location of the second asset and the second timestamp, the second timestamp indicating a second time when the second asset update was created by the second service provider, receiving a first search request from a first user associated with the first entity, the first search request identifying a subset of assets belonging to the first entity, based on the first search request, retrieving, from the first entry, the first asset identifier, the first timestamp, and the location of the first asset, placing a first map marker on a first map, the first map marker corresponding to the location of the first asset, providing the first map to the first user, the first map marker being interactive, in response to an interaction by the first user on the first map marker, the first map displaying the first asset identifier and the first timestamp, receiving a second search request from a second user associated with the second entity, the second search request identifying a subset of assets belonging to the second entity, based on the second search request, retrieving, from the first entry, the second asset identifier, the second timestamp, and the location of the second asset, placing a second map marker on a second map, the second map marker corresponding to the location of the second asset, and providing the second map to the second user, the second map marker being interactive, in response to an interaction by the second user on the second map marker, the second map displaying the second asset identifier and the second timestamp.

An example system including at least one processor and memory including instructions executable by the processor to: receive, from a first service provider over a network, a first asset update, the first asset update including a first asset identifier identifying a particular first asset, a first timestamp, and a location of the first asset, the first asset being owned by a first entity, the first service provider having been approved by the first entity to provide updates regarding a set of assets belonging to the first entity, create and store a first asset entry associated with the particular first asset, the asset entry including the location of the first asset and the first timestamp, the first timestamp indicating a first time when the first asset update was created by the first service provider, receive, from a second service provider over the network, a second asset update, the second asset update including a second asset identifier identifying a particular second asset, a second timestamp, and a location of the second asset, the second asset being owned by a second entity, the second service provider having been approved by the second entity to provide updates regarding a set of assets belonging to the second entity, the second entity being unrelated and remote from the second entity, create and store a second asset entry associated with the particular second asset, the second asset entry including the location of the second asset and the second timestamp, the second timestamp indicating a second time when the second asset update was created by the second service provider, receive a first search request from a first user associated with the first entity, the first search request identifying a subset of assets belonging to the first entity, based on the first search request, retrieve, from the first entry, the first asset identifier, the first timestamp, and the location of the first asset, place a first map marker on a first map, the first map marker corresponding to the location of the first asset, provide the first map to the first user, the first map marker being interactive, in response to an interaction by the first user on the first map marker, the first map displaying the first asset identifier and the first timestamp, receive a second search request from a second user associated with the second entity, the second search request identifying a subset of assets belonging to the second entity, based on the second search request, retrieve, from the second entry, the second asset identifier, the second timestamp, and the location of the second asset, place a second map marker on a second map, the second map marker corresponding to the location of the second asset; and provide the second map to the second user, the second map marker being interactive, in response to an interaction by the second user on the second map marker, the second map displaying the second asset identifier and the second timestamp.

### BRIEF DESCRIPTION OF THE DRAWINGS

FIG. 1 depicts an example map showing location of multiple assets according to some embodiments.

FIG. 2 depicts a block diagram of an example environment capable of tracking and monitoring multiple assets being handled and transported by different asset service providers over any number of networks.

FIG. 3 depicts a block diagram of an example asset tracking system according to some embodiments.

FIG. 4 depicts a flow chart of a method of registering a new asset service provider according to some embodiments.

FIG. 5 depicts a flow chart of a method of creating a new category of assets according to some embodiments.

FIG. 6 depicts a flow chart of a method of capturing asset data of an asset and updating the asset tracking system with the captured asset data according to some embodiments.

FIG. 7 depicts a flow chart of a method of monitoring an asset as it is handled by one asset service provider and then another asset service provider according to some embodiments.

FIG. 8 depicts a flow chart of a method of searching for assets, and updating, in real-time, the search results as assets are updated according to some embodiments.

FIG. 9 depicts a flow chart of a method of multiple asset service providers creating asset entries and storing them in the asset tracking system according to some embodiments.

FIG. 10 depicts an example of a method of retrieving assets that fit the entity's search criteria according to some embodiments.

FIG. 11 depicts an example of asset records according to some embodiments.

FIG. 12 depicts a block diagram of an example computing device according to some embodiments.

### DETAILED DESCRIPTION

Tracking assets is often critical to the efficiency and productivity. An asset tracking system may allow a company or entity to track and update a physical asset to determine the person who is in possession of the physical asset, condition, and current location of the asset. By tracking physical assets and their condition, the company may reduce the amount of lost or damaged equipment, which may hurt the company's bottom line.

Historically, each company or entity must develop its own method and operation for tracking assets. Beyond the expense of implementation, design of the system such that the location of assets is easily tracked costs each individual company considerable resources and manpower. Even after each company develops and implements its own system, the systems are not easily understandable (e.g., assets are not easily located) by people with knowledge of the system or those that simply want to know where a particular item is located.

Systems and methods described herein include a centralized system that assists different, unrelated companies to track their assets. The asset tracking system, in some embodiments, enables assets to be easily located by displaying markers and information on a map that is understandable by those who implemented the system but also by those without knowledge of the asset tracking system (e.g., the system may be easily understandable through a simplified, map with map markers indicating locations of equipment, when the information was last updated, and optionally equipment condition information).

Further, because the asset tracking system is centralized, the process of providing location updates of assets may also be unified and simplified. Employees or service providers may register and log into the centralized asset tracking system (e.g., accessible over the Internet). Based on the login (e.g., over their smart phone), the centralized asset tracking system may provide an interface capable of receiving information (e.g., location and/or condition of the asset) for a particular entity. The employee or service provider may easily add information to the interface and provide an update or record for a particular asset to the asset tracking system.

When an authorized person with the entity wishes to track or monitor the assets, they may log into the centralized asset tracking system. The asset tracking system may identify assets and/or maps associated with the entity based on the login, and provide a map (e.g., building layout, geographic map, location map, floor plan, or the like) with map markers indicating location of any number of assets. The authorized person may filter the interface to only display a type or category of asset, search for a geographic location, search for a particular asset, or search for asset conditions (e.g., age of the asset, recently purchased assets, asset functions, and/or damage of asset). Each map marker may be interactive and may allow the authorized person to engage and/or hover a cursor over the map marker to reveal information regarding the asset (e.g., name of asset and time of last update). In some embodiments, the authorized person may interact with the map marker to generate another interface indicating all or some of the tracked information regarding the asset (e.g., asset identifier, location of the asset, name of the service provider that provided the last update, names of service providers that provided any number of updates, condition, damage, when purchased, when serviced, alarm conditions, maintenance information, and/or the like).

By providing a centralized asset tracking system that enables service providers to provide updates and reveals locations of assets on a map interface, the system greatly reduces burdens of each individual entity creating their own system as well as develop their own proprietary systems for their service providers to provide updates. Further, the system enables different entities to access the same set of assets (or a subset). For example, a first entity may track a set of their assets using the centralized asset tracking system. Later, the first entity may hire an agency to maintain and service a subset of the assets. The first entity may configure the centralized asset tracking system such that users of the agency (e.g., agents) may log into the centralized asset tracking system. The asset tracking system may associate the assets with the subset of assets of the first entity and enable the agency users to provide asset updates (e.g., provide updates indicating changes in location and/or condition of an asset), add new assets to the asset tracking system on behalf of the first entity, view a map indicating locations of only the subset of assets (and not other assets of the set that are not part of the subset), and interact with map markers of assets of the subsets. Agency users are easily added to the asset tracking system and their access may be similar to the first entity's previous service providers (e.g., through the Internet). The agency may provide service and have rights to any number of assets of any number of entities through the asset tracking system. Similarly, the first entity may revoke the privileges of the agency and the agency may no longer be able to update asset information and/or view the map that indicates the subset of assets.

In another example, the asset may be professional services provided by a service provider. The asset tracking system may enable tracking, in real-time, using systems discussed herein. For example, different professional service providers may provide painting services and the service in question is the asset. In this example, different professional service providers (e.g., painters) may log into the asset tracking system and indicate the status of the asset (e.g., percentage of painting completed, location of job or jobs, quality of work, amount of paint, needed resources, or the like). The map may indicate the location of each asset (e.g., job) as well a job identifier and time information (e.g., timestamp) of last update. This tracking may allow an entity or service provider to verify that services were provided, optimize the service professional's team's efficiency, and provide updates to customers waiting for service, or detect problems.

As discussed herein, the entity may send a request to the asset tracking system for search results for a subset of assets. The asset tracking system may present this information in the form of a map, with map markers representing the last known geographic location of one or more assets being monitored by the asset monitor. A user may interact with the map markers on the map and be presented with information regarding when the asset record for a particular asset represented by a map marker on the map was last updated. The map may be retrieved from the asset tracking system or a third-party map provider (e.g., Google Maps, MapQuest, or the like).

The asset tracking system allows asset service providers to utilize a variety of methods to input an asset into the asset tracking system, such as barcode readers, smartphones, laptop computers, desktop computers, and the like. The asset service provider may indicate that they are in possession of a particular piece of equipment, an indication of the condition, location of use, or location of a destination for the piece of equipment.

An asset service provider may input a current location of an asset by using a smartphone, a bar code scanner, and the like. The asset may be tagged with a physical or virtual matrix barcode, such as a Quick Response (QR) code, a bar code, a radio-frequency identification (RFID) code, and the like. The asset tracking system may receive the input of the current location of the asset and track, in real-time, the location of the asset as it is in transit by utilizing the location of the asset service provider's smartphone or other portable computing devices.

The asset tracking may monitor real-time information regarding the status, geographic location, condition, and current speed if the asset is in motion. In some embodiments, if the asset is in motion, the asset tracking system may utilize tracking information to determine the expected time until arriving at a destination. The asset service provider may upload digital images of the asset; the asset tracking system may extract metadata associated with the digital images to update properties associated with the asset. The asset tracking system may track, in real-time, that an asset is in possession of one asset service provider and then is in possession of another asset service provider.

In some embodiments, one asset service provider of one entity, registered and authenticated by the asset tracking system, may request to store an asset entry. The asset entry may be associated with one asset located at a geographic location. The request to store the asset entry may include an uploading account identifier, timestamp of one asset entry, one or more first categorical identifiers associated with one asset entry, and/or the geographic location associated with one asset entry (e.g., retrieved from a smart phone GPS at the time the entry is provided, created, or updated).

The asset tracking system may store the asset entry in an asset record datastore. Another user of a different entity, registered and authenticated by the asset tracking system, may request to store another asset entry. The other asset entry may be associated with a different asset located at another geographic location. The other request to store the other asset entry may include an uploading account identifier, timestamp of the asset entry, one or more first categorical identifiers associated with the other asset record, and the other geographic location associated with the other asset entry. The service provider record system may store the other service provider record in the service provider record datastore. In some embodiments, an asset may be a physical asset, or a professional service provided by a service provider.

In various embodiments, assets are also categorized by categorical identifiers. In various embodiments, an asset may be a medical device such as a portal x-ray machine, intravenous (IV) pole, blood glucose meter, and the like. In some embodiments, an asset is a construction equipment, furniture, electronics, etc. In one embodiment, assets may be a professional service provided by a service provider, such as a plumber, locksmith, information technology (IT) specialist, and the like.

In various embodiments, the asset entry displayed in a user interface may appear to be a part of the web page, web site, or application (e.g., from an owner or operator of the web page, web site, or application). It will be appreciated that the asset tracking system may enable the delivery of asset entry such that it appears to be coming from the web page, web site, or application thereby keeping customers and/or viewers of the user interface to be engaged with the original domain (e.g., the web page, web site, or application).

Further, it will be appreciated that the asset tracking system may receive asset entries from different asset service providers of different entities or companies. The different asset service providers (from different entities) may be associated with different web pages, web sites, and/or applications. As a result, centralized asset entries generated from one or more asset service providers may be leveraged by different sites. In some embodiments, a user may register with the asset tracking system such that their asset entries to be stored in the asset tracking system. Further, the user may configure the asset tracking system to enable their asset entries to be provided to a group or subset of web pages, web sites, and/or applications such that their asset entries appear to be a part of the web page, web site, or application (e.g., from the owner or operator of the web page, web site, or application). In some embodiments, asset entries associated with assets that belong to the same project are grouped together and shown together on a project profile page. Each of the asset entries may provide a link to the user who submitted the respective asset entry.

In some embodiments, code may be retrieved from the asset tracking system to embed in a web page or application (e.g., a smartphone “app”). The embedded code may provide, via a network, an asset entry request to the asset tracking system. The asset tracking system may receive the asset entry request and, based at least in part on the domain identifier associated with the sending web page or application, retrieve the requested asset entry. In one example, the asset tracking system may retrieve asset entries based on the search criteria and location identifiers (e.g., coordinates or other location information) associated with the map. The asset tracking system may deliver the retrieved asset entries to the web page and/or a user's digital device.

In various embodiments, an entity system may specify a geofence for an asset. For example, an entity may specify that a portable x-ray machine asset may not leave the grounds of the hospital but may be placed in different locations on certain floors of the hospital. If the asset tracking system receives input (e.g., an asset update from a service provider) that the portable x-ray machine is in a geographic location that is outside of the hospital, the asset tracking system may send a notification to the entity. In the case where the asset is an IT specialist assigned with a work order at a particular location, the asset service provider may be a smartphone in possession of the IT specialist. An entity, such as the IT specialist's company or a business at the particular location, may send a request to the asset tracking system to send a notification to the entity when the asset arrives or leaves a predefined set of boundaries around the business.

The asset tracking system may receive asset data associated with an asset from the asset service provider and extract metadata from the asset data. The asset tracking system may use the received asset data or extracted metadata to update or create an asset entry associated with the asset. The asset data may be any kind of digital content or media, including, but not limited to, pictures, text, video, sound, graphics, map markers, interactive programming, or any combination of the above.

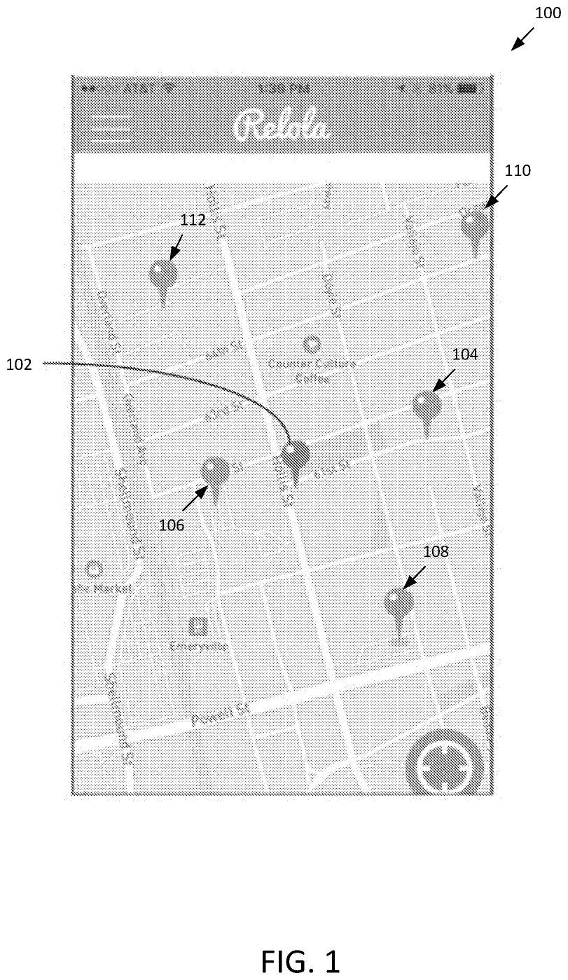

FIG. 1 depicts an example map 100, showing the location of multiple assets. An entity may send a search request to the asset tracking system for a set or subset of the entity's assets or assets associated with a particular project. In response to the received search request, the asset tracking system may generate search results based on the search request. The asset tracking system may present the search results in the form of a map. In various embodiments, the search results are presented in the form of a graph, a chart, or some combination thereof.

The map 100 includes multiple map markers that are placed in the last geographic location associated with each of the multiple map markers. For example, the placement of a map marker 102, at the corner of Hollis Street and 61^{st} Street, represents the last or most up-to-date location of the asset represented by the map marker 102. When a user of the entity system interacts with the map marker 102, the asset tracking system 202 may present to the user of the entity system information regarding the asset entry associated with the asset represented by the map marker 102. In some embodiments, the asset tracking system presents a timestamp of the last time the asset was logged at the particular location, or in other words when the latest asset entry associated with the asset represented by the map marker 102 was received. Other information that may be presented includes an account identification (ID) of the asset service provider (e.g., a user identifier) who logged the asset at the particular location, ID associated with the asset, time duration in the current location, and status of the asset, such as in use, ready for use, service required, and returned.

In the illustrated embodiment, map markers may be displayed in different colors or have different shapes. The color or shape may change in response to when the asset record was last updated, for example, if the asset associated with map marker 104 has been in the location placed on the map 100 for longer than a predetermined period, the color of the map marker 104 may change. In various embodiments, other factors that may cause the color or shape of the map marker to change may include a change in the status of the asset, configuration, condition of the asset, significant changes to the assets, and/or other conditions.

In some embodiments, the example map 100 may be updated in real-time; the asset tracking system may present the example map 100 with map markers 102, 104, 106, 108, and 110. The map marker 110 may represent the last logged location of a particular asset. When the location of the particular asset changes, the example map 100 may, in real-time, erase the map marker 110, and update the example map 100 with a map marker 112.

Although the example map 100 is depicted as a region, it will be appreciated that the example map 100 may depict a floor plan, a building plan, a geographic region, streets, hallways, a warehouse map, or the like. In some embodiments, the example map 100 may depict any number of updates regarding any number of assets. For example, the example map 100 may include any number of map markers and locations for where they were moved over a predetermined period of time (e.g., based on a date range provided by the entity to receive the depiction of the example map 100).

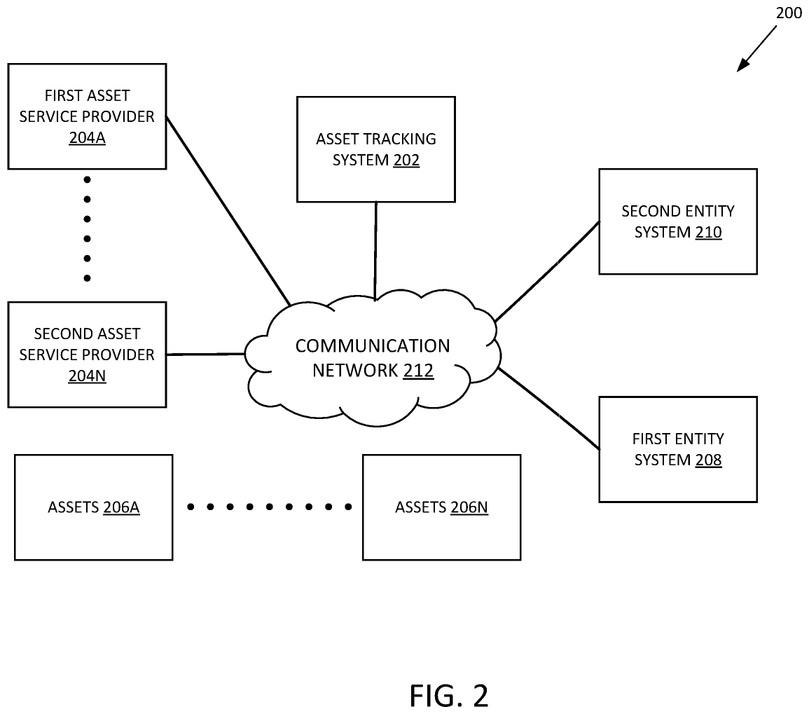

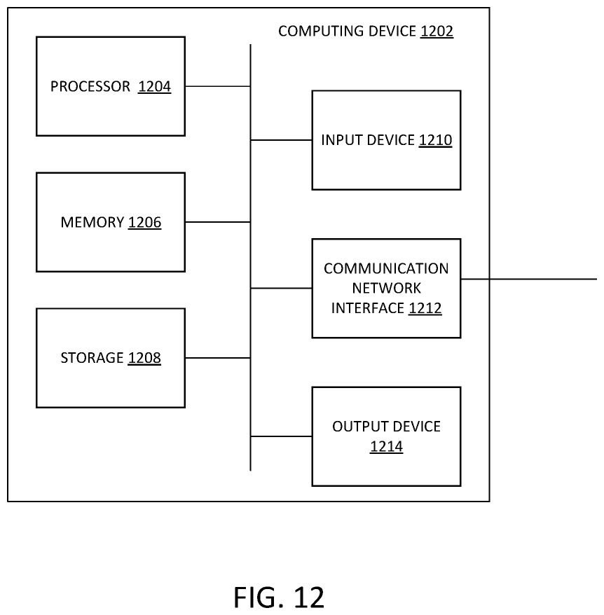

FIG. 2 depicts a block diagram of an example environment 200 capable of tracking and monitoring multiple assets being handled and transported by different asset service providers over any number of networks. In this example, the environment 200 includes an asset tracking system 202, asset service provider 204A to 204N (individually, asset service provider 204 collectively), asset 206A to 206N (individually, asset 206 collectively), a first entity system 208, a second entity system 210, and a communication network 212. The asset tracking system 202, asset service provider 204-1 to 204-N, the first entity system 208, the second entity system 210 may each be or include any number of digital devices. A digital device is any device with a processor and memory. Digital devices are further discussed herein (e.g., see FIG. 12).

The asset tracking system 202 may receive requests to register the service provider and/or assets. After authenticating the registration, the asset tracking system 202 may receive ID data of the first asset service provider 204A associated with the first entity system 208. The first asset service provider 204A may input a current location of the asset 206A by using a smartphone, a bar code scanner, and the like. An asset identifier of the asset 206A may be inputted into the asset tracking system 202. The asset identifier may be a physical or virtual matrix barcode, such as a QR code, a bar code, RFID code, and the like. The asset tracking system 202 may receive the asset identifier and current location of the asset and log or track the location of the asset 206A.

In one example, when an asset arrives at its destination location, the first asset service provider 204A may input the current location of the asset 206A (e.g., from the gps of the asset service provider's digital device and/or entering a physical location), an asset identifier of the asset 206A, and may specify that the first asset service provider 204A is no longer in possession of the asset 206A. In some embodiments, the first asset service provider 204A may input the current location of the asset 206A by using an application associated with the asset tracking system 202 or the first entity system 208.

The asset tracking system 202 may track any number of assets of any number of entities using updates from any number of asset service providers. The asset tracking system 202 may utilize the same or different maps for different entities. For example, the asset tracking system 202 may provide a map of a downtown region indicating locations of a first set of physical assets to a first entity. The asset tracking system 202 may provide the same map indicating locations of a different set of physical assets or services to a different, unrelated entity (i.e., unrelated to the first entity).

The asset tracking system 202 may receive from one of the first entity system 208 and the second entity system 210 a search request. In response to the received search request, the asset tracking system may generate search results based on the search request. The search results may be a map (e.g., the map 100) and locations of assets based on the search request. In this example, the search request may limit the map displayed to the searcher and/or the assets located on the map.

The asset tracking system may present the search results in the form of a map, such as the example map 100 of FIG. 1. In various embodiments, the search results are presented in the form of a graph, a chart, or some combination thereof. When a user interacts with a map marker in the example map 100 of FIG. 1, the asset tracking system 202 may present a timestamp associated with the latest asset entry associated with the asset represented by the map marker.

An asset service provider 204 system may be or include one or more mobile devices (e.g., smartphones, cell phones, smartwatches, tablet computer, or the like), desktop computers, laptop computers, and/or the like. A service provider 204 (e.g., asset service provider) may utilize a smart device (e.g., digital device) to provide updates or information regarding any number of assets.

An entity system and/or the asset service provider 204 may register an entity account on the asset tracking system 202. The asset entry may be linked or associated with the entity account and/or user ID of the asset service provider 204, time at which the asset entry was uploaded (e.g., by timestamp), tags identifying categories, domains (e.g., websites, web pages, applications, an operator of a website or application, and/or an owner of the website or application), location information (e.g., map locations or coordinates), and/or the like.

In various embodiments, the asset tracking system 202 may receive a request to register a user of the first entity system 208. After authenticating the registration, the asset tracking system 202 may receive service provider identifiers of asset service providers associated with the first entity system 208. The user of the first entity system 208 may associate any of a number of levels of permission for each of the asset service providers. For example, the first entity system 208 may allow all asset service providers associated with the first entity system 208 to update information regarding all assts (e.g., allowed to update certain fields of asset entries, such as a timestamp associated with the asset entry and a geographic location of the asset associated with the asset entry). In some embodiments, the first entity system 208 may limit certain asset service providers to only access or update some information regarding an asset (e.g., such as a condition of a portable x-ray machine, to be updated by x-ray technicians).

In some embodiments, the asset tracking system 202 generates asset entries created by any number of asset service providers 204 (e.g., asset service provider 204A-204N) of an asset (e.g., physical asset, digital asset, or services provided). The user-generated asset entry may be associated with one or more categories (e.g., using tags identifying a type or category of asset, condition of asset, last maintenance, and/or the like) or one or more entity system, such as the first entity system 208, and the second entity system 210. Multiple asset service providers 204 may interact with the same asset 206. For example, the asset 206A is a portable x-ray machine. Many different hospital personnel may interact with the portable x-ray machine and provide updates to the asset tracking system 202; each of the different hospital personnel may be one of the multiple asset service providers 204 depicted in FIG. 2.

In this example, an x-ray technician, orderly, and radiologist may all interact with the portable x-ray machine in different ways. An orderly may be responsible for moving the portable x-ray machine from one location of the hospital to another. The first entity system 208, such as a hospital, may specify that an asset service provider 204 corresponding to the orderly may be geofenced to the confines of the hospital. For example, the asset tracking system may provide an alarm to an entity, another user, and/or any number of asset service providers if the orderly provides an update that indicates that the location of an asset is outside the confines of a geofenced region. Other service providers may not be geofenced. For example, another asset service provider, e.g., a hospital administrator, may move an asset to any location or hospital and provide an update that indicates the location (e.g., the location being beyond the geofenced region that limits the orderly). In this example, a geofenced region refers to a limit of the location of an asset based on information maintained at the asset tracking system 202.

Based on the level of permission, the asset tracking system 202 may allow the asset service provider 204 corresponding to the orderly to only update certain fields of the asset entry associated with the portable x-ray machine, such as a geographic location of the asset and timestamp of the asset entry. The asset tracking system 202 may allow the asset service provider 204 corresponding to the x-ray technician or radiologist to update fields of the asset entry associated with the portable x-ray machine, such as the status or condition of the portable x-ray machine.

In some embodiments, the asset tracking system 202 may provide asset entries based on a geographic location associated with the asset, type of asset (e.g., physical asset, digital asset, or services provided), a timestamp associated with the latest asset entry, and the like. The asset tracking system 202 may provide different content to a wide variety of different web pages (e.g., provided and maintained by different entities), web sites, and/or applications thereby enabling different web pages, web sites, and/or applications to rely on centralized content provided by the asset tracking system without recreating the content and/or embedded code at each web page, web site, and/or application.

The asset tracking system 202 may receive from any one of the asset service providers 204, the first entity system 208, and the second entity system 210, asset data regarding one or more assets. The asset tracking system 202 may receive asset data and extract metadata from the asset data. The metadata and the asset data may be used to create or update an asset entry associated with the asset. The asset data may be any kind of digital content or media, including, but not limited to, pictures, text, video, sound, graphics, map markers, interactive programming, or any combination of the above.

In some embodiments, the asset tracking system 202 includes one or more datastores for a plurality of users across a plurality of domains (e.g., different entities and/or domains within the same entity). A domain contains a group of computers that can be accessed and administered with a common set of rules. A particular asset service provider 204, who has registered as being associated with a particular entity, may be able to create or retrieve asset entries from the asset record datastore of the asset tracking system 202 that is associated with the particular entity. An asset service provider 204 may have access to multiple datastores across a plurality of entities. For example, an IT specialist may be registered to have access to a domain datastore associated with the company the IT specialist works for and another domain datastore associated with companies where the IT specialist's services are provided. That particular user may provide search queries of asset entries at both datastores. In other embodiments, the user is only able to do search queries of asset entries on one domain content datastore at a time.

An asset 206 may be a physical asset, such as a portable x-ray machine, or a professional service such as a painter, plumber, or locksmith. The type of asset may determine which asset fields make up the asset entry in an interface to a relevant service provider. In the case where the asset 206 is a physical asset, asset fields may include an origin location and destination location of the asset, time duration in the location, condition of the asset, and device configuration. Each asset entry of the asset 206 may correspond to a change in one more field of the asset entry. Each asset 206 may include one asset record; each asset record includes multiple asset entries. In the case where the asset 206 is a professional service provided by a service provider, each asset entry may be associated with an individual workorder of the service professional. Asset fields for a professional service may include, for example, an address where the professional service will take place, estimated duration of professional service, and type of equipment required for the professional service. Regardless of the type of asset, asset entries may include asset fields such as account ID of the asset service provider creating the asset entry, timestamp of the asset entry, the status of the asset at the time the asset entry is being created, and location of the asset at the timestamp of the asset entry.

Each of the first entity system 208 and the second entity system 210 may associate one or more levels of permission for each of multiple asset service providers associated with each entity system. For example, the first entity system 208 may allow all asset service providers associated with the first entity system 208 to update certain fields of asset entries, such as a timestamp associated with the asset entry and a current geographic location of the asset associated with the asset entry. In some embodiments, the first entity system 208 may only allow certain fields of an asset entry to be limited to one or more different service providers. For example, an X-ray technician may update an asset entry reflecting a condition of a portable x-ray machine. In some embodiments, the first asset service provider may have access to both the first entity system 208 and the second entity system 210.

In some embodiments, a user of the first entity system 208 may specify a geofence for one or more assets associated with the first entity system 208. The user of the first entity system 208 may also specify a type and frequency of notification if a particular asset leaves the geofence specified by the user of the first entity system 208.

In some embodiments, communication network 212 represents one or more computer networks (e.g., LANs, WANs, and/or the like). The communication network 212 may provide communication between any of the asset tracking system 202, the asset service provider 204, the assets 206, the first entity system 208, and the second entity system 210. In some implementations, the communication network 212 comprises computer devices, routers, cables, uses, and/or other network topologies. In some embodiments, the communication network 212 may be wired and/or wireless. In various embodiments, the communication network 212 may comprise the Internet, one or more networks that may be public, private, IP-based, non-IP based, and so forth.

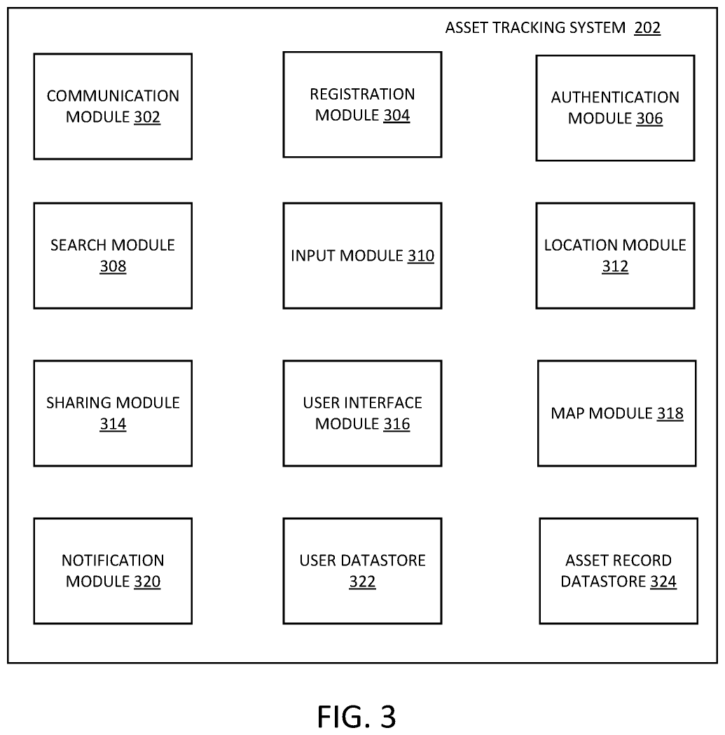

FIG. 3 depicts a block diagram of an example asset tracking system 202 according to some embodiments. The asset tracking system 202 includes a communication module 302, a registration module 304, an authentication module 306, a search module 308, an input module 310, a location module 312, a sharing module 314, an user interface module 316, a map module 318, a notification module 320, a user datastore 322, and an asset record datastore 324.

The communication module 302 may send and receive requests, images, or data between any of the modules or datastores of the asset tracking system 202 and components of the example environment 200 of FIG. 2. Similarly, the asset tracking system 202 may send and receive requests, images, or data across the communication network 212 to any device or system.

In some embodiments, the registration module 304 may be configured to create asset service provider accounts and entity accounts for asset service providers and entity systems respectively. The registration module 304 may be configured to update account information for asset service providers and entity systems. When a new asset service provider account or a new entity account, an account identifier (e.g., a login identifier) and password may be required.

In various embodiments, accounts for asset service providers and entities may include identification information. Account identification information may include, for example, an email address, password, phone number, demographic information, and/or the like. In various embodiments, an asset service provider account or an entity account may be required to be registered and/or login to their account before creating asset entries with the asset tracking system 202 and retrieving asset entries from the asset tracking system 202.

In various embodiments, the authentication module 306 authenticates a login and password. The authentication module 306 may authenticate an asset service provider account or an entity account by comparing the login and password with a database of registered asset service provider account or the entity account and/or confirming permissions or data rights. It will be appreciated that asset service provider accounts or the entity accounts may be authenticated in many ways, including, but not limited to, device identifiers, biometrics, encryption keys, cookies, and/or the like. In some embodiments, the authentication module 306 may make additional requests of membership numbers or other forms of identification to indicate that the user belongs to one or more professional associations. In some embodiments, the authentication module 306 may, after authentication, determine data permissions prior to allowing particular asset service provider accounts to store to content within the asset record datastore 324. In some embodiments, the authentication module 306 authenticates the assets and locations associated with asset entries, to determine if they are real assets and not falsified.

The search module 308 receives a request for a service provider or a service provider record and/or creates a search query based on one or more search criteria. The search module 308 may be configured to filter and organize according to one or more filter criteria, including the categorical identifiers, which may include a type of asset, tags, timestamp of the asset entry, latest or most up-to-date geographical location, account identification, and others. Other filtering criteria could include but are not limited to keywords, the status of the asset associated with the asset entry, and the time duration spent at the latest or the most up-to-date geographical location. The search module 308 may output the results of the search query in the form of a map, a list, or in some other electronic forms. When a user of the asset tracking system 202 interacts with an map marker in the example map 100 of FIG. 1, the search module 308 may present a timestamp associated with the latest asset entry associated with the asset represented by the map marker.

In one example, a user of an entity my provide a username and password to the asset tracking system 202. The authentication module 306 may confirm and authenticate the user's username and password. The authentication module 306 may further identify an account associated with the user's account, and identify domain(s) and/or set(s) of assets associated with the entity (or the domain(s) and/or set(s) of assets that the user has access to, based on their personal permissions). The search module 308 may then receive a search query from the user, and the search module 308 may provide a map of the particular assets that are both relevant to the search query and are associated with the entity/rights of the user.

In one embodiment, the input module 310, may receive a request, images, or data from any of the first entity system 208, the second entity system, the asset service provider 204 to create asset service provider accounts, entity accounts, entity records, entity assets, asset data, and the like.

In some embodiments, the input module 310 extract or receives metadata from the asset data received by one of the asset service providers 204. The asset data may be any kind of digital content or media, including, but not limited to, pictures, text, video, sound, graphics, map markers, interactive programming, or any combination of the above. The metadata extracted or received by the input module 310 may include information regarding the time an update of an asset (e.g., asset entry) was received, geographic location associated with the service provider that provided the update (e.g., GPS measurements from the service provider's smartphone), digital video, and/or image(s) of the asset. In various embodiments, the input module 310 may identify a categorical identifier (e.g., provided by the service provider such as “medical equipment,” “staff equipment,” “consumer equipment,” or the like) associated with one or more asset entries. In one embodiment, categorical identifiers may include a type of assets, such as physical assets or professional service. Categorical identifiers may be used to filter and organize search results. A categorical identifier may be any identifier (e.g., a tag) that may be used to group similar types of equipment. In various embodiments, the entity may create and define any number of categorical identifiers.

In various embodiments, the location module 312 determines or receives geographic location (e.g., location information) regarding an asset associated with an asset record. As discussed herein, in some embodiments, the asset record may be associated with a project as well as geographic location information. It will be appreciated that the location module 312 may also determine or receive geographic location information regarding a cluster of assets located in proximity to each other and/or a cluster of projects with some common categorical identifier. In some embodiments, location module 312 may utilize or receive GPS information, Wi-Fi signals, cellular signals, and/or manual address information provided by the service provider to determine or assist in determining location information of an asset.

The sharing module 314, receive permissions and enable the first entity system 208 to share asset records in an electronic mail (email), text, SMS, and/or social networking websites such as Facebook®, Twitter® with one or more of the first entity system, the second entity system 210, and any of the asset service provider 204. The sharing module 314 may be utilized to create any number of rules that indicate notification preferences (e.g., when notifications or alarms are sent, who is to receive the notifications or alarms, and how the notifications or alarms are sent (such as by email, text message, or both)).

In some embodiments, the user interface module 316 presents images and/or audio corresponding to asset records according to some embodiments. The user interface module 316 may present the example map 100 of FIG. 1, which includes multiple map markers placed in the last or most up-to-date geographic location associated with each of the multiple map markers. In one embodiment, the user interface module 316 presents a user interface to allow a user of the first entity system 208, the second entity system 210 to register and authenticate entity accounts, asset service provider accounts, associate levels of permission for each asset service provider account, and provide notification preferences and frequencies for each asset.

As discussed herein, the map and map markers enables assets to be easily located by displaying markers and information on a map that is understandable by those who implemented the system but also by those without knowledge of the asset tracking system (e.g., the system may be easily understandable through a simplified, map with map markers indicating locations of equipment, when the information was last updated, and optionally equipment condition information).

The asset tracking system 202 may identify assets and/or maps associated with the entity based on the login, and provide a map (e.g., building layout, geographic map, location map, floor plan, or the like) with map markers indicating location of any number of assets. The authorized person may filter the interface to only display a type or category of asset, search for a geographic location, search for a particular asset, or search for asset conditions (e.g., age of the asset, recently purchased assets, asset functions, and/or damage of asset). Each map marker may be interactive and may allow the authorized person to engage and/or hover a cursor over the map marker to reveal information regarding the asset (e.g., name of asset and time of last update). In some embodiments, the authorized person may interact with the map marker to generate another interface indicating all or some of the tracked information regarding the asset (e.g., asset identifier, location of the asset, name of the service provider that provided the last update, names of service providers that provided any number of updates, condition, damage, when purchased, when serviced, alarm conditions, maintenance information, and/or the like).

In various embodiments, the map module 318 provides a map of a location from third-party map provider (e.g., Google Maps, MapQuest, or the like). The map may include map markers associated with projects over a large geographic area, such as the example map 100 shown in FIG. 1. Map module 318 facilitates the entity system's access to access entries by displaying them on the map 100 and allowing the user to zoom in or out to display a smaller or larger geographic region respectively. As a user zooms in or out to display a smaller or larger geographic region, the location and the number of map markers in a cluster may change. In some embodiments, the map module 318 may update or add map markers to map 100, in real-time as new asset entries are received and stored in asset record datastore 324.

In some embodiments, the notification module 320 may provide notification(s) to the first entity system 208 when an asset record associated with an asset of the first entity system is created or updated. Notification preferences may include email, text messages, instant messages, and telephone calls. The frequency of the notification may depend on many factors, including the cost to replace the asset and the criticality of the asset to the entity. In one example, the notification module 320 sends a notification to the second entity system 210 that an asset associated with the second entity system 210 has left the geofence specified by the second entity system.

The user datastore 322, may be any structure and/or structures suitable for storing user account records (e.g., an active database, a relational database, a self-referential database, a table, a matrix, an array, a flat file, a documented-oriented storage system, a non-relational No-SQL system, an FTS-management system such as Lucene/Solar, and the like). In some embodiments, the user account may be an entity account or an asset service provider account in response to receiving a request form the registration module 304 to create an entity account or an asset service provider account. Entity accounts and asset service provider accounts include account identification information, including the account ID, email address, password, phone number, demographic information, and/or the like. In some embodiments, entity accounts may further include the account ID of asset service provider accounts associated with the entity account.

In various embodiments, the asset record datastore 324 may be any structure and/or structures suitable for storing asset records and asset entries (e.g., an active database, a relational database, a self-referential database, a table, a matrix, an array, a flat file, a documented-oriented storage system, a non-relational No-SQL system, an FTS-management system such as Lucene/Solar, and the like). In some embodiments, the asset record datastore 324 includes multiple asset records. Each asset record may be associated with one asset. Each asset entry of a particular asset may correspond to change in one more field of the asset entry.

In addition to asset records and asset entries, categorical identifiers may also be saved in the asset record datastore 324 to facilitate the retrieval of the data. Categorical identifiers may include account identifiers, the geographical location of assets, timestamp of the asset record, type of asset tags, and/or others.

A module may be hardware or software. In some embodiments, the module may configure one or more processors to perform functions associated with the module. Although different modules are discussed herein, it will be appreciated that the asset tracking system 202 may include any number of modules performing any or all functionality discussed herein.

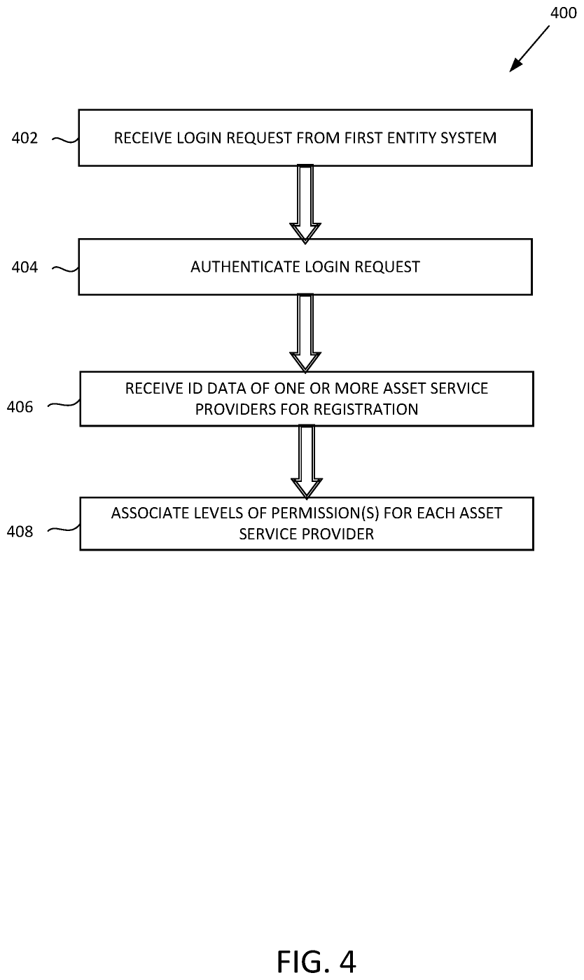

FIG. 4 depicts a flow chart 300 of registering a new asset service provider according to some embodiments. In step 402, the input module 310 may receive from the first entity system 208 a login request. The login request may include a username, password, and optionally an account identifier. In some embodiments, the login request includes device identifiers, biometrics, encryption keys, cookies, and/or the like. In various embodiments, the username is associated with the account identifier.

In step 404, the authentication module 306 authenticates the information provided by the login request from the first entity system 208 and confirms authorization of the first entity system 208. If the authentication module 306 determines that the login request from the first entity system 208 does not match one of the user accounts stored in the user datastore 322, the input module 310 may provide an indication that there is not an account and may send a request to the registration module 304 to create an entity account associated with the first entity system 208.

In step 406, the input module 310 may receive from the first entity system 208 identification data (e.g., a user identifiers) for one or more asset service providers 204 (e.g., the first asset service provider 204A). The identification data provided by the first entity system 208 may include an account ID of the first asset service provider 204A and/or a user identifier. The input module 310 may receive this information and send a request to the user datastore to create an asset service provider account associated with the first asset service provider 204A.

In step 408, the input module 310 may receive, from the first entity system 208, a level of permission for the first asset service provider 204A. For example, the first entity system 208 may only allow the first asset service provider 204A to read and/or write only certain aspects of information related to particular assets (e.g., fields of asset entries, such as a timestamp and geographic location associated with the asset entry).

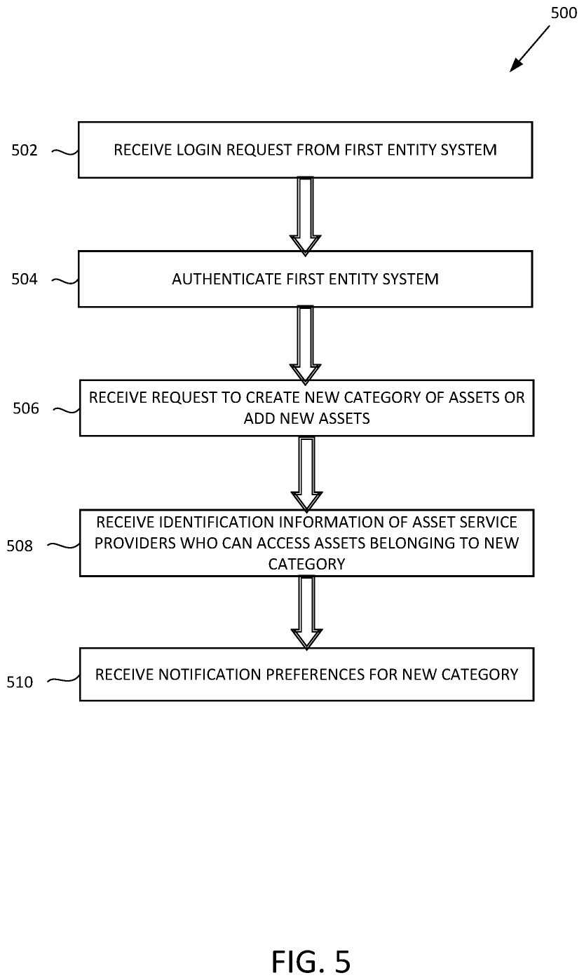

FIG. 5 depicts a flow chart 500 of creating a new category of assets according to some embodiments. In step 502, the input module 310 may receive from the first entity system 208 a login request. The login request may include the account identifier and password. In some embodiments, the login request includes device identifiers, biometrics, encryption keys, cookies, and/or the like.

In step 504, the authentication module 306 authenticates the information provided by the login request from the first entity system 208 determines if the user is authorized. If the authentication module 306 determines that the login request from the first entity system 208 is not authorized, the input module 310 may send a request to the registration module 304 to create an entity account associated with the first entity system 208.

Once the first entity system 208 has been authenticated, step 506 may proceed. In step 506, the input module 310 may receive from the first entity system 208, a request to create a new asset category. The request to create the new category may include a categorical identifier, a brief description of the asset category, and asset ID for one or more assets that belong to this category (if available). For example, the first entity system 208 may send a request to the asset tracking system 202 to create a new asset category, “medical devices,” which may include assets with an asset ID which starts with “XRAY,” such as the asset 206A. The input module 310 may send this information to the asset record datastore 324 to create an asset record that corresponds to the asset 206A.

In step 508, the input module 310 may receive account ID of one or more asset service provider or entities which may have access to asset records associated with assets of that particular category. For example, the first entity system may send a request that the first asset service provider 204A is authorized to have access to one or more assets associated with the first entity system 208.

In step 510, the input module 310 may receive a notification preference for one or more assets associated with the first entity system 208. Notification preferences may include email, text messages, instant messages, and telephone calls. The frequency of the notification may depend on many factors, including the cost to replace the asset and the criticality of the asset to the entity. The input module 310 may send this information to the notification module 320 and the asset record datastore 324. In one example, the notification module 320 sends a notification to the first entity system 208 that an asset associated with the second entity system 210 has left the geofence specified by the second entity system.

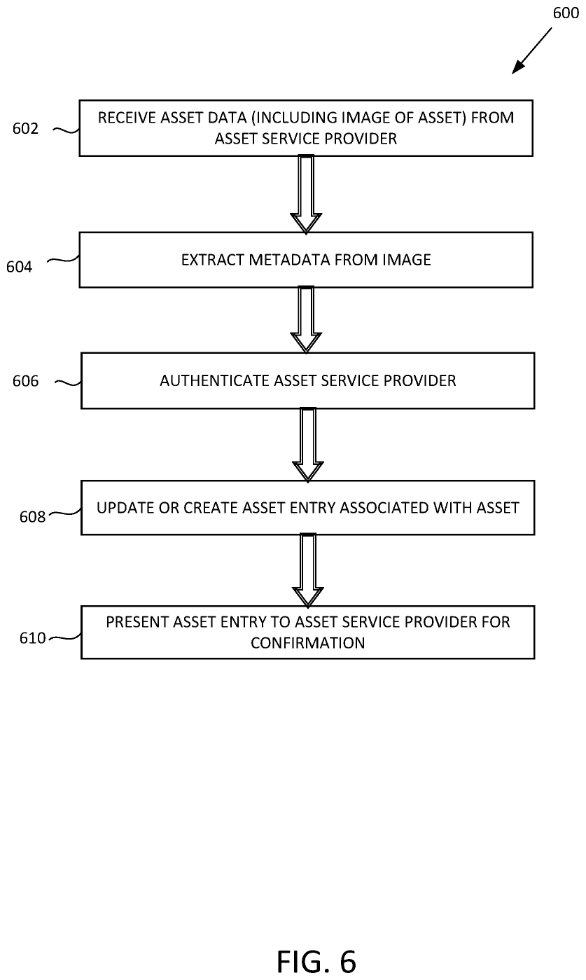

FIG. 6 depicts a flow chart 600 of capturing asset data of an asset and updating the asset tracking system with the captured asset data according to some embodiments. In step 602, the input module 310 may receive asset data from the first asset service provider 204A. The asset data may be any kind of digital content or media, including, but not limited to, pictures, text, video, sound, graphics, map markers, interactive programming, or any combination of the above.

In step 604, the input module 310 may extract or retrieve metadata from the asset data received from the first asset service provider 204A. The metadata extracted or retrieved by the input module 310 may include information regarding the time, and geographic location digital video or image was captured. In various embodiments, the input module 310 may identify the categorical identifier associated with one or more asset entries. In one embodiment, categorical identifiers may include a type of assets, such as physical asset or professional service. For example, the input module 310 may receive a digital image of asset 206N, a portable x-ray machine. The input module 310 may extract metadata from the asset data to determine that the first asset service provider 204A captured the digital image. The input module 310 may send the extracted metadata, the fact that the digital image was captured by the first asset service provider 204A to the authentication module 306 to determine if the first asset service provider 204A is authorized to provide the digital image for the portable x-ray machine.

In step 606, the authentication module 306 authenticates the first asset service provider 204A. Subsequently, the authentication module 306 may confirm that the first asset service provider is authorized to provide asset data for a particular asset, such as asset 206N, the portable x-ray machine. Once the authentication module 306 determines that the first asset service provider 204A is authorized to provide asset data for asset 206N, step 608 may proceed. If the authentication module 306 determines that the first asset service provider 204A is not authorized to provide asset data, the notification may send a notification to the entity system associated with asset 206N, such as the second entity system 210 of unauthorized access of asset 206N.

In step 608, the input module 310 may send a request to the asset record datastore 324 to create or update an asset entry associated with the portable x-ray machine with the asset data and the metadata extracted from the asset data. For example, the input module 310 may send a request to the asset record datastore 324 to create an asset entry for the portable x-ray machine. The asset entry may include the digital image captured by the first asset service provider 204A, the date, timestamp, and geographical location of the portable x-ray machine extracted or received from the metadata of the digital image, and the account ID associated with the first asset service provider 204A.

In step 610, the notification module 320 may send a notification to the user of the first entity system 208 of the newly created asset entry for the portable x-ray machine. The user of the first entity system 208 may receive the notification and send a request to the user interface module 316 to view the created asset entry and the digital image captured by the first asset service provider 204A. The user interface module 316 may present the newly created asset entry for the portal x-ray machine to the user of the first entity system 208.

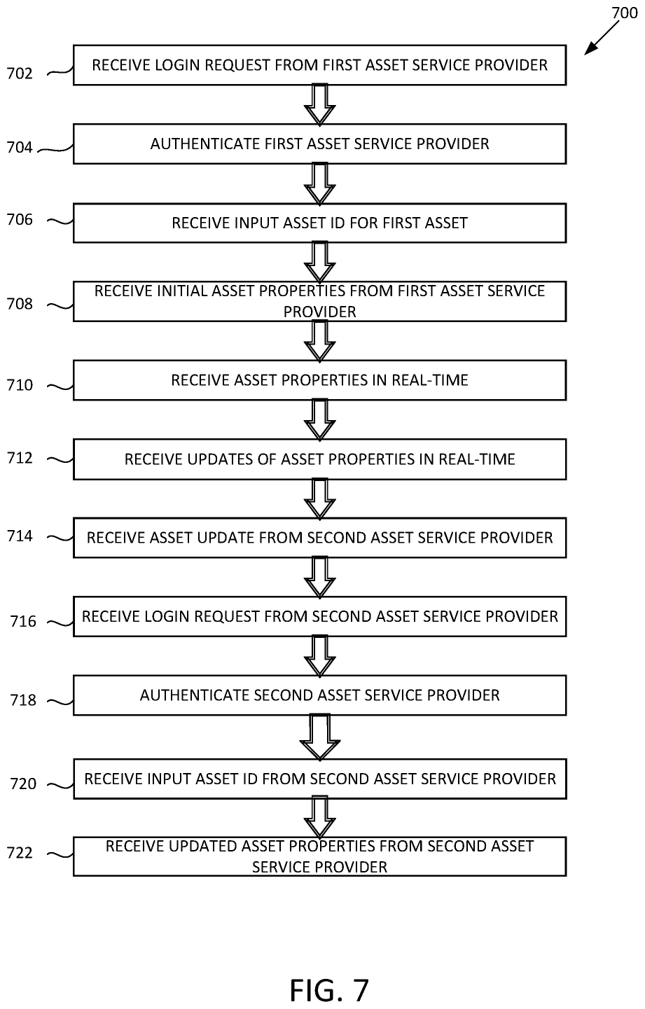

FIG. 7 depicts a flow chart 700 of monitoring an asset as it is first handled by one asset service provider and then handled by another asset service provider according to some embodiments. In step 702, the input module 310 may receive from the first entity system 208 a login request. The login request may include the account identifier and password. In some embodiments, the login request includes device identifiers, biometrics, encryption keys, cookies, and/or the like.

In step 704, the authentication module 306 authenticates and confirms authorization based on the information provided by the login request from the first entity system 208. If the authentication module 306 determines that the login request from the first entity system 208 does not match one of the user accounts stored in the user datastore 322, the input module 310 may send a request to the registration module 304 to create an entity account associated with the first entity system 208.

In step 706, the asset tracking system 202 may receive input from the first asset service provider 204A, a current geographic location of the asset 206A. The input may be inputted into the asset tracking system 202 manually or using a physical or virtual matrix barcode, such as a QR code, a bar code, RFID code, and the like. In various embodiments, the asset service provider 204A may provide asset data. The asset data may also include any kind of digital content or media, including, but not limited to, pictures, text, video, sound, graphics, map markers, interactive programming, or any combination of the above. For example, the first asset service provider 204A may provide an asset update indicating a location of the asset, an asset identifier (e.g., identifying the particular asset), and a time of the asset update. The first asset service provider 204A may further provide images of the asset and/or other asset data. The asset tracking system 202 may store the information and provide all or some of the information as a part of the interactive map discussed herein.

The metadata extracted or retrieved by the input module 310 may include information regarding the time, and geographic location digital video or image was captured. In some embodiments, the metadata extracted by the input module 310 may include an account ID or user ID associated with the user who captured the asset data. Once the first asset service provider 204A inputs the asset 206A, the first asset service provider 204A may interact with the asset 206A.

For example, if the first asset service provider 204A is an orderly. The orderly may be responsible for moving the portable x-ray machine from an examination to a sanitization room in a hospital. When the orderly arrives at the one examination room, he may input a description of the asset (e.g., select an asset category and/or provide description information of the portable x-ray machine into the asset tracking system 202) using his smartphone and scanning a QR code affixed to one side of the portable x-ray machine.

In step 708, the asset record datastore 324 may receive a request to create an asset entry associated with the asset 206A using at least the data received in step 706. Continuing the above example, the asset record datastore 324 may receive a request to create an asset entry associated with the portable x-ray machine. The asset entry may include an asset identifier (e.g., unique to the asset 206A), a timestamp of the current time the information was provided by the service provider, the location of the portable x-ray machine being in the one examination room (e.g., GPS coordinates, room number, or the like), and/or a condition of the portable x-ray machine.

In optional step 710, as the orderly moves the portable x-ray machine from the one examination room into the sanitization room, the asset tracking system 202 may use the real-time location of the first asset service provider 204A to determine a real-time location of the portable x-ray machine. When the orderly arrives in the sanitization room, the orderly may input the portable x-ray machine into the asset tracking system 202 by scanning the QR code with his smartphone.

In step 712, the asset record datastore 324 may receive a request to create another asset entry associated with the asset 206A, the portable x-ray machine. The other asset entry may include a timestamp of the current time, an asset identifier associated with the x-ray machine, the location of the portable x-ray machine being in the sanitization room, and optionally a condition of the portable x-ray machine, that the machine has been sanitized. As properties of the asset, such as the geographical location or condition, changes the asset tracking system 202 may create an asset entry.

After the portable x-ray machine has been sanitized, a different orderly may be assigned the task of moving the sanitization room to a different examination room, in which case, step 714 may proceed. In step 714, the input module 310 receives a request from the second asset service provider 204N, a different orderly, to create yet another asset entry associated with the 206A, the portable x-ray machine. The second entry may include the asset identifier of the portable x-ray machine, an identifier associated with the second service provider, a timestamp of the time the asset entry was sent, and a location.

In step 716, the input module 310 may receive from the second asset service provider 204N a login request.

In step 718, the authentication module 306 authenticates and confirms authorization. If the authentication module 306 determines that the second asset service provider 204N is not authorized to provide asset data, the notification may send a notification to the entity system associated with asset 206N, such as the first entity system 208 of unauthorized access of asset 206A.

In step 720, the asset tracking system 202 may receive input from the second asset service provider 204N, a current geographic location of the asset 206A. The input may be inputted into the asset tracking system 202 with a physical or virtual matrix barcode, such as a QR code, a bar code, RFID code, and the like. Continuing the above example, the asset record datastore 324 may receive a request to create an asset entry associated with the portable x-ray machine. The asset entry may include a timestamp of the current time, the location of the portable x-ray machine being in the sanitization room, and a condition of the portable x-ray machine.

In step 722, as the orderly moves the portable x-ray machine from the sanitization room into the other examination room, the asset tracking system 202 may optionally use the real-time location of the second asset service provider 204A to determine a real-time location of the portable x-ray machine. When the orderly arrives in the sanitization room, the orderly may input the portable x-ray machine into the asset tracking system 202 by scanning the QR code with his smartphone. The second asset service provider 204A may add another asset entry when the movement of the asset is completed. This asset entry may identify the second service provider and include the asset identifier, new location of the asset, time of this asset entry, and/or other information (e.g., condition of the asset, picture of the asset, and/or the like).

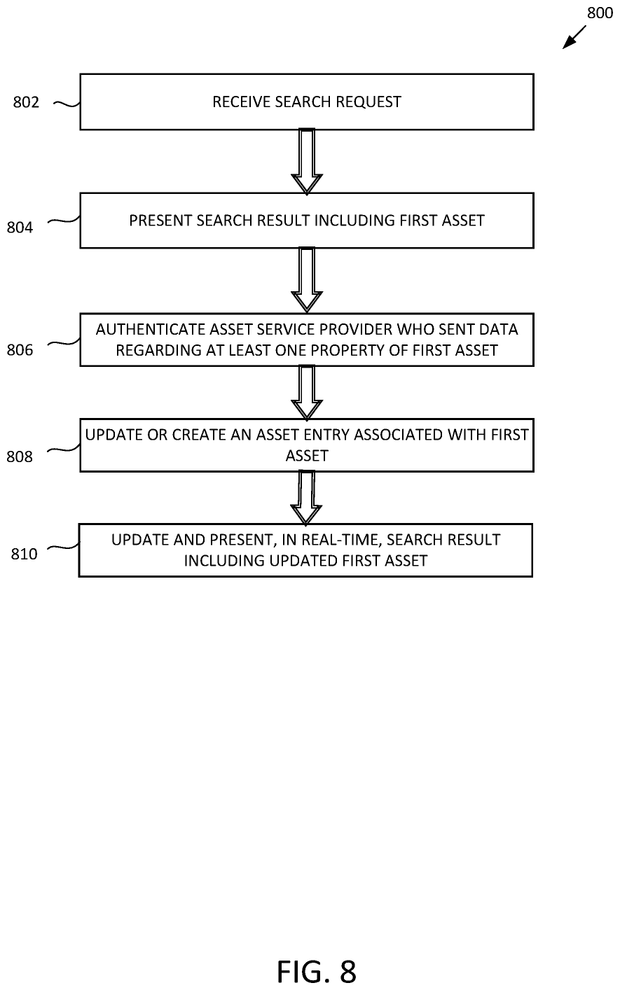

FIG. 8 depicts a flow chart 800 of searching for assets, and updating, in real-time, the search results as assets are updated according to some embodiments. In step 802, the search module 308 may receive, from the input module 310, a search request. The search request may include search criteria such as status of the asset associated with the asset entry and time duration at the latest or the most up-to-date geographical location. The search module 308 may output a search result based on the search criteria. The search result may include a map of a region (e.g., building, floor plan, city, town, state, forest, or the like) as well as any number of map markers indicating locations of assets based on asset entries.

It will be appreciated that the search module 308 may receive a map request or provide a map by default (e.g., without a search request).

In step 804, the user interface 316 may present the search result from the search module 308. The search results may be presented in the form of a map, a list, or in some other electronic forms. An example of the map may be seen in FIG. 1. When a user of the asset tracking system 202 interacts with an map marker in the example map 100 of FIG. 1, the search module 308 may present a timestamp associated with the latest asset entry associated with the asset represented by the map marker.

The example map 100 includes multiple map markers, 102 to 112. Each of the multiple map markers represents the last or most up-to-date location of a particular asset. In step 806, when the location of the particular asset changes, the input module may send a request to the asset record datastore 324 to create a new asset entry.

In step 808, the asset record datastore 324 may receive the request and create the new asset entry.

In step 810, the user interface 316 may receive a request for the example map 100 to erase, in real-time, the map marker 110 and update the example map 100 with the map marker 112, which may represent the changed location of the particular asset. In one embodiment, when other properties of the particular asset changes, the example map 100 may, in real-time, update the color or map marker shape of one or more map markers on the example map 100.

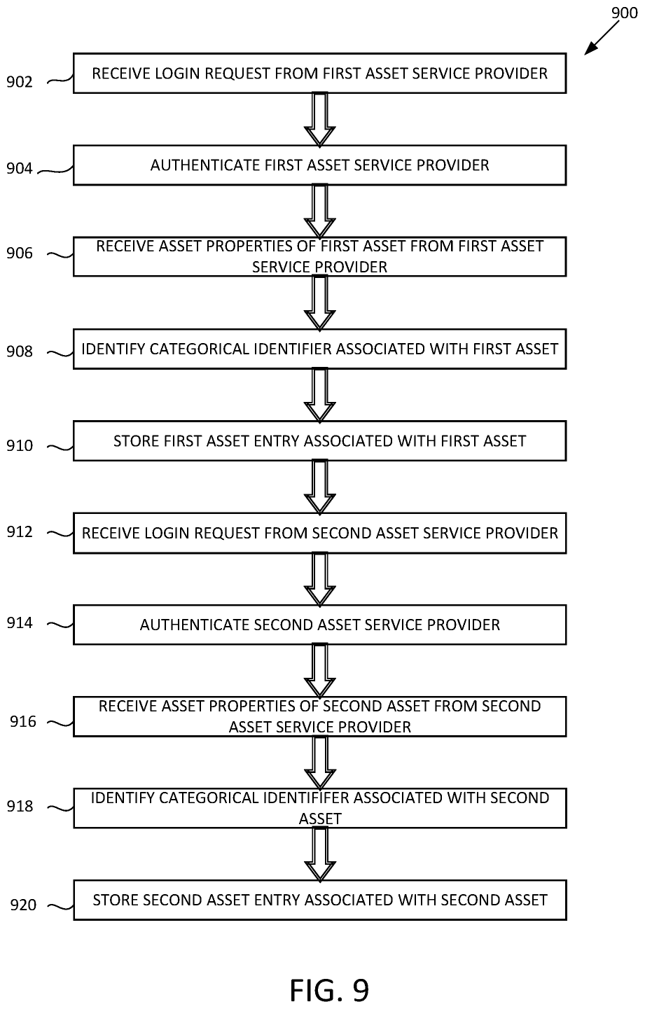

FIG. 9 depicts a flow chart 900 of multiple asset service providers creating asset entries and storing them in the asset tracking system 202 according to some embodiments. In step 902, the input module 310 may receive from the first asset service provider 204A a login request. The login request may include the account identifier and password. In some embodiments, the login request includes device identifiers, biometrics, encryption keys, cookies, and/or the like.

In step 904, the authentication module 306 authenticates and confirms authorization. If the authentication module 306 determines that the login request from the first asset service provider 204A does not match one of the user accounts stored in the user datastore 322, the input module 310 may send a request to the registration module 304 to create an asset service provider account associated with the first asset service provider 204A.

In step 906, the input module 310 may receive an input of a first asset 206A. The input may be received from the first asset service provider 204A of the first entity system 208. The input may be inputted into the asset tracking system 202 with a physical or virtual matrix barcode, such as a QR code, a bar code, RFID code, and the like. In one embodiment, the input may be a digital image or digital video of the first asset 206A. The input module may extract metadata from the digital image or digital video. The input and metadata extracted/retrieved from the input may be used to create an asset entry.

In step 908, search module 308 and/or service provider identifies categorical identifiers associated with the first asset 206A. Categorical identifiers may include a type of assets, such as a physical asset or a professional service provided by a service provider.

In step 910, the asset record datastore 324 may receive a request from the search module 308 and the input module 310 to create the latest or most up-to-date asset entry associated with the first asset 206A.

In step 912, the input module 310 may receive from the second asset service provider 204N a login request. The login request may include the account identifier and password. In some embodiments, the login request includes device identifiers, biometrics, encryption keys, cookies, and/or the like.

In step 914, the authentication module 306 authenticates the information and determines authorization.

In step 916, the input module 310 may receive an input of a second asset 206N. The input may be received from the second asset service provider 204N of the second entity system 210. The input may be inputted into the asset tracking system 202 with a physical or virtual matrix barcode, such as a QR code, a bar code, RFID code, and the like. In one embodiment, the input may be a digital image or digital video of the second asset 206N. The input module may extract metadata from the digital image or digital video. The input and metadata extracted from the input may be used to create an asset entry.

In step 918, search module 308 and/or service provider identifies the categorical identifiers associated with the second asset 206N. Categorical identifiers may include a type of assets, such as a physical asset or a professional service provided by a service provider.

In step 920, the asset record datastore 324 may receive a request from the search module 308 and the input module 310 to create the latest or most up-to-date asset entry associated with the second asset 206N. Asset entries associated with the first asset 206A, the first asset 206A being accessible by the first entity system 208, are stored in the same datastore as asset entries associated with the second asset 206B, the second assets 206N being accessible by the second entity system 210. In some embodiments, the first entity system 208, and the second system entity 210 are completely separate from each other.

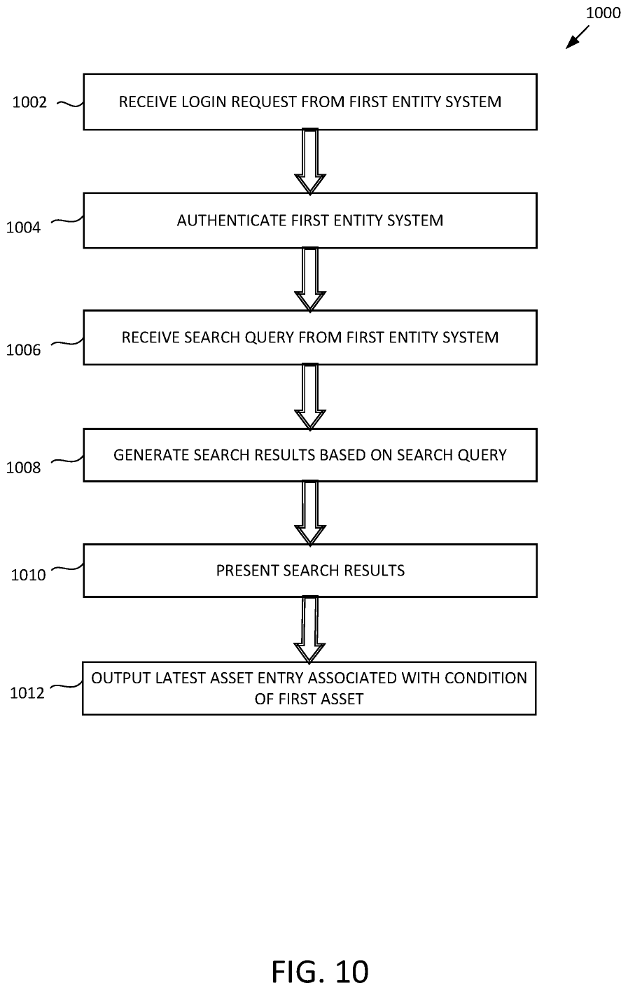

FIG. 10 depicts an example of a method 1000 of retrieving assets that fit the entity's search criteria according to some embodiments. In step 1002, the input module 310 may receive from the first entity system 208 a login request. The login request may include the account identifier and password. In some embodiments, the login request includes device identifiers, biometrics, encryption keys, cookies, and/or the like.

In step 1004, the authentication module 306 authenticates the information provided by the login request from the first entity system 208 and confirms authorization.

In step 1006, the search module 308 receives a request for a service provider or a service provider record and/or creates a search query based on one or more search criteria. The search module 308 may be configured to filter and organize according to one or more filter criteria, including the categorical identifiers, which may include a type of asset, tags, timestamp of the asset entry, the latest or the most up-to-date geographical location, account identification, and others. Other filtering criteria could include but are not limited to keywords, the status of the asset associated with the asset entry, and time duration at the latest or most up-to-date geographical location.

In step 1008, the search module 308 may generate search results based on the search query.

In step 1010, the search results may be presented in the form of a map, a list, or in some other electronic forms. Each of the one or more assets in the search results may be represented as one or more map markers in the example map 100 of FIG. 1. In various embodiments, the search results may be presented in the form of a list, or in some other electronic forms.

In step 1012, a user of the asset tracking system 202 may interact with a map marker in the example map 100 of FIG. 1. When the user interacts with the map marker, the asset record datastore 324 may receive a request for the latest or most up-to-date condition of the asset associated with the map marker. The status of the asset in use, ready for use, service required, returned, sanitized, and needs sanitization.

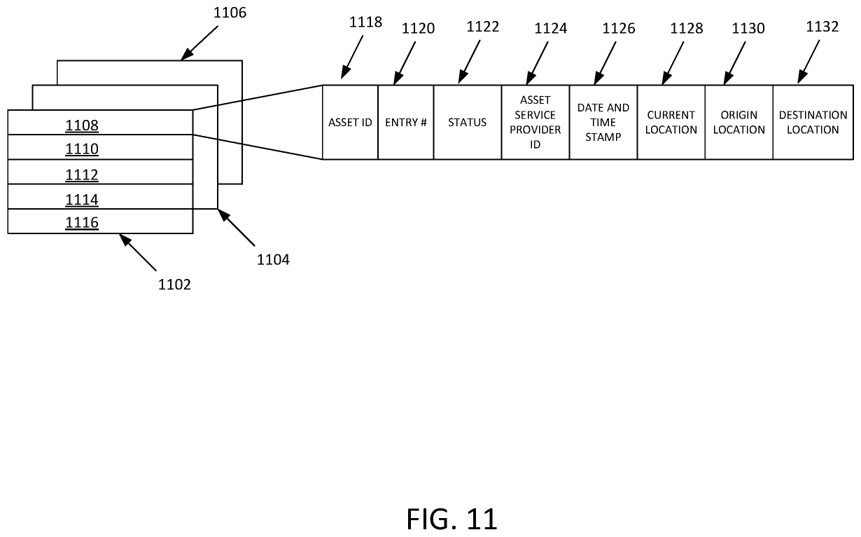

FIG. 11 depicts an example of asset records according to some embodiments. An asset record may be associated with each asset of the example environment 200. Asset records may be stored in the asset record datastore 324 regardless of the entity system associated with the asset associated with the asset record. For example, each asset record 1102, 1104, and 1106 may each be associated with an asset of the example environment 200. Each asset record, such as the asset record 1002 includes multiple asset entries, 1108, 1110, 1112, 1114, and 1116. Fields that make up the asset entry may depend on the type of asset. For example, if the asset 206 is a physical asset, asset fields may include an origin location and destination location of the asset, time duration in the location, condition of the asset, and device configuration. If the asset 206 is a professional service provided by a service provider, each asset entry may be associated with an individual workorder of the service professional. Asset fields may include an address where the professional service will take place, estimated duration of professional service, and type of equipment required for the professional service. Regardless of the type of asset, asset entries may include asset fields such as account ID of the asset service provider creating the asset entry, timestamp of the asset entry, the status of the asset at the time the asset entry is being created, and location of the asset at the timestamp of the asset entry.

Asset fields 1118 through 1132 make up the asset entry 1108. The asset fields associated with the same asset record may include a subset of asset fields. The asset field 1118 may store an asset ID; each asset may be assigned a unique ID. The asset field 1120 may store an entry number; this may be used to aid in identifying the latest or most up-to-date asset entry. Entry numbers may be incremented as new asset entries are created. The asset field 1122 may store a status of the asset at the time the asset entry was created. The status of the asset may include such as in use, ready for use, service required, and returned. The asset field 1124 may store an asset service provider ID. The asset field 1126 may store a date and timestamp of when the asset entry was created. The asset field 1128 may store a geographic location of the asset at the time the asset entry was created. If the asset is in motion, the asset field 1130 may store the geographic location of an origin of the asset entry at the time the asset entry was created, while the asset field 1132 may store the geographic location of a destination of the asset entry.

FIG. 12 depicts a block diagram of an example computing device 1202 according to some embodiments. Any asset service provider 204, the first entity system 208, the second entity system, and the asset tracking system 202 may comprise an instance of computing device 1202. Computing device 1202 comprises a processor 1204, a memory 1206, a storage 1208, an input device 1210, a communication network interface 1212, and an output device 1214. Processor 1204 is configured to execute executable instructions (e.g., programs). In some embodiments, the processor 1204 comprises circuitry or any processor capable of processing the executable instructions.

Memory 1206 stores data. Some examples of memory 1206 include storage devices, such as RAM, ROM, RAM cache, virtual memory, etc. In various embodiments, working data is stored within memory 1206. The data within memory 1206 may be cleared or ultimately transferred to storage 1208.

Storage 1208 includes any storage configured to retrieve and store data. Some examples of storage 1208 include flash drives, hard drives, optical drives, and/or magnetic tape. Each of memory system 1206 and storage system 1208 comprises a computer-readable medium, which stores instructions or programs executable by processor 1204.

Input device 1210 is any device that inputs data (e.g., mouse, keyboard, stylus). Output device 1214 outputs data (e.g., speaker, display, virtual reality headset). It will be appreciated that storage 1208, input device 1210, and output device 1214 may be optional. For example, routers/switchers may comprise processor 1204 and memory 1206 as well as a device to receive and output data (e.g., communication network interface 1212 and/or output device 1214).

Communication network interface 1212 may be coupled to a network (e.g., communication network 212) via communication network interface 1212. Communication network interface 1212 may support communication over an Ethernet connection, a serial connection, a parallel connection, and/or an ATA connection. Communication network interface 1212 may also support wireless communication (e.g., 802.11 a/b/g/n, WiMAX, LTE, Wi-Fi). It will be apparent that communication network interface 1212 may support many wired and wireless standards.

The output device 1214 outputs data (e.g., speaker, display, virtual reality headset). It will be appreciated that the storage 1208, input device 1210, and output device 1214 may be optional. For example, routers/switchers may comprise processor 1204 and memory 1206 as well as a device to receive and output data (e.g., communication network interface 1212 and/or output device 1214).

An engine may be hardware or software. In some embodiments, the engine may configure one or more processors to perform functions associated with the engine. Although different engines are discussed herein, it will be appreciated that the asset tracking system 202 may include any number of engines performing any or all functionality discussed herein.

1. A nontransitory computer readable medium comprising instructions executable by a processor, the instructions being executable to perform a method, the method comprising:
receiving, from a first service provider over a network, a first asset update, the first asset update including a first asset identifier identifying a particular first asset, a first timestamp, and a location of the first asset, the first asset being owned by a first entity, the first service provider having been approved by the first entity to provide updates regarding a set of assets belonging to the first entity;
creating and storing a first asset entry associated with the particular first asset, the asset entry including the location of the first asset and the first timestamp, the first timestamp indicating a first time when the first asset update was created by the first service provider;
receiving, from a second service provider over the network, a second asset update, the second asset update including a second asset identifier identifying a particular second asset, a second timestamp, and a location of the second asset, the second asset being owned by a second entity, the second service provider having been approved by the second entity to provide updates regarding a set of assets belonging to the second entity, the second entity being unrelated and remote from the second entity;
creating and storing a second asset entry associated with the particular second asset, the second asset entry including the location of the second asset and the second timestamp, the second timestamp indicating a second time when the second asset update was created by the second service provider;
receiving a first search request from a first user associated with the first entity, the first search request identifying a subset of assets belonging to the first entity;
based on the first search request, retrieving, from the first entry, the first asset identifier, the first timestamp, and the location of the first asset;
placing a first map marker on a first map, the first map marker corresponding to the location of the first asset;
providing the first map to the first user, the first map marker being interactive, in response to an interaction by the first user on the first map marker, the first map displaying the first asset identifier and the first timestamp;
receiving a second search request from a second user associated with the second entity, the second search request identifying a subset of assets belonging to the second entity;
based on the second search request, retrieving, from the first entry, the second asset identifier, the second timestamp, and the location of the second asset;
placing a second map marker on a second map, the second map marker corresponding to the location of the second asset; and
providing the second map to the second user, the second map marker being interactive, in response to an interaction by the second user on the second map marker, the second map displaying the second asset identifier and the second timestamp.

2. The nontransitory computer readable medium of claim 1, wherein the first and second map display a location.

3. The nontransitory computer readable medium of claim 1, the wherein first asset provider being the second asset provider.

4. The nontransitory computer readable medium of claim 1, wherein providing the first map to the first user comprises displaying a web page depicting the first map, the first search request being received from the first user using a web site.

5. The nontransitory computer readable medium of claim 1, wherein the first search request being received from the first user using a remote web site operated by a third-party and providing the first map to the first user comprises providing code to display the first map within a section of a web page of the web site such that the first map appears as if the first map is provided by the third-party.

6. The nontransitory computer readable medium of claim 1, wherein the first asset update includes an image of the particular first asset taken by the first service provider at or near a time that the first service provider provided the first asset update, the first map being interactive to display the image of the particular first asset when the first user interacts with the first map marker.

7. The nontransitory computer readable medium of claim 1, wherein the first asset is equipment and the second asset is a service.

8. The nontransitory computer readable medium of claim 1, wherein the first asset is equipment and the second asset is a service.

9. The nontransitory computer readable medium of claim 1, the method further comprising:
receiving, from any number of service providers over the network, a plurality of updates, the plurality of updates each including the first asset identifier identifying the particular first asset, a timestamp for that particular update, and a location of the first asset at or near the time that the particular update was created; and
creating and storing each of the updates;
wherein the first search request further including a date range, wherein the first map includes a set of map markers, each of the set of map markers being located on the first map at or near the locations of the first asset at a time within the date range, each of the map markers displaying, when interacted with by the first user, the timestamp corresponding to that particular update created during the duration.

10. The nontransitory computer readable medium of claim 9, wherein each of the set of map markers is colored based on time of the corresponding update.

11. A method comprising:
receiving, from a first service provider over a network, a first asset update, the first asset update including a first asset identifier identifying a particular first asset, a first timestamp, and a location of the first asset, the first asset being owned by a first entity, the first service provider having been approved by the first entity to provide updates regarding a set of assets belonging to the first entity;
creating and storing a first asset entry associated with the particular first asset, the asset entry including the location of the first asset and the first timestamp, the first timestamp indicating a first time when the first asset update was created by the first service provider;
receiving, from a second service provider over the network, a second asset update, the second asset update including a second asset identifier identifying a particular second asset, a second timestamp, and a location of the second asset, the second asset being owned by a second entity, the second service provider having been approved by the second entity to provide updates regarding a set of assets belonging to the second entity, the second entity being unrelated and remote from the second entity;
creating and storing a second asset entry associated with the particular second asset, the second asset entry including the location of the second asset and the second timestamp, the second timestamp indicating a second time when the second asset update was created by the second service provider;
receiving a first search request from a first user associated with the first entity, the first search request identifying a subset of assets belonging to the first entity;
based on the first search request, retrieving, from the first entry, the first asset identifier, the first timestamp, and the location of the first asset;
placing a first map marker on a first map, the first map marker corresponding to the location of the first asset;
providing the first map to the first user, the first map marker being interactive, in response to an interaction by the first user on the first map marker, the first map displaying the first asset identifier and the first timestamp;
receiving a second search request from a second user associated with the second entity, the second search request identifying a subset of assets belonging to the second entity;
based on the second search request, retrieving, from the first entry, the second asset identifier, the second timestamp, and the location of the second asset;
placing a second map marker on a second map, the second map marker corresponding to the location of the second asset; and
providing the second map to the second user, the second map marker being interactive, in response to an interaction by the second user on the second map marker, the second map displaying the second asset identifier and the second timestamp.

12. The method of claim 11, wherein the first and second map display a location.

13. The method of claim 11, the wherein first asset provider being the second asset provider.

14. The method of claim 11, wherein providing the first map to the first user comprises displaying a web page depicting the first map, the first search request being received from the first user using a web site.

15. The method of claim 11, wherein the first search request being received from the first user using a remote web site operated by a third-party and providing the first map to the first user comprises providing code to display the first map within a section of a web page of the web site such that the first map appears as if the first map is provided by the third-party.

16. The method of claim 11, wherein the first asset update includes an image of the particular first asset taken by the first service provider at or near a time that the first service provider provided the first asset update, the first map being interactive to display the image of the particular first asset when the first user interacts with the first map marker.

17. The method of claim 11, wherein the first asset is equipment and the second asset is a service.

18. The method of claim 11, wherein the first asset is equipment and the second asset is a service.

19. The method of claim 11, the method further comprising:
receiving, from any number of service providers over the network, a plurality of updates, the plurality of updates each including the first asset identifier identifying the particular first asset, a timestamp for that particular update, and a location of the first asset at or near the time that the particular update was created; and
creating and storing each of the updates;
wherein the first search request further including a date range, wherein the first map includes a set of map markers, each of the set of map markers being located on the first map at or near the locations of the first asset at a time within the date range, each of the map markers displaying, when interacted with by the first user, the timestamp corresponding to that particular update created during the duration.

20. The method of claim 19, wherein each of the set of map markers is colored based on time of the corresponding update.

21. A system comprising:
at least one processor;
memory including instructions executable by the processor to:
receive, from a first service provider over a network, a first asset update, the first asset update including a first asset identifier identifying a particular first asset, a first timestamp, and a location of the first asset, the first asset being owned by a first entity, the first service provider having been approved by the first entity to provide updates regarding a set of assets belonging to the first entity;
create and store a first asset entry associated with the particular first asset, the asset entry including the location of the first asset and the first timestamp, the first timestamp indicating a first time when the first asset update was created by the first service provider;
receive, from a second service provider over the network, a second asset update, the second asset update including a second asset identifier identifying a particular second asset, a second timestamp, and a location of the second asset, the second asset being owned by a second entity, the second service provider having been approved by the second entity to provide updates regarding a set of assets belonging to the second entity, the second entity being unrelated and remote from the second entity;
create and store a second asset entry associated with the particular second asset, the second asset entry including the location of the second asset and the second timestamp, the second timestamp indicating a second time when the second asset update was created by the second service provider;
receive a first search request from a first user associated with the first entity, the first search request identifying a subset of assets belonging to the first entity;
based on the first search request, retrieve, from the first entry, the first asset identifier, the first timestamp, and the location of the first asset;
place a first map marker on a first map, the first map marker corresponding to the location of the first asset;
provide the first map to the first user, the first map marker being interactive, in response to an interaction by the first user on the first map marker, the first map displaying the first asset identifier and the first timestamp;
receive a second search request from a second user associated with the second entity, the second search request identifying a subset of assets belonging to the second entity;
based on the second search request, retrieve, from the second entry, the second asset identifier, the second timestamp, and the location of the second asset;
place a second map marker on a second map, the second map marker corresponding to the location of the second asset; and
provide the second map to the second user, the second map marker being interactive, in response to an interaction by the second user on the second map marker, the second map displaying the second asset identifier and the second timestamp.
